(19) United States
(12) Patent Application Publication
(10) Pub. No.: US 2017/0210239 A1
(43) Pub. Date: Jul. 27, 2017

(54) ELECTRICAL CHARGING CONTROL DEVICE, CHARGING METHOD AND CHARGING SYSTEM THEREOF

(71) Applicant: FOXNUM TECHNOLOGY CO., LTD., Taichung (TW)

(72) Inventors: DONG-SHENG LIN, Daya (TW); YUNG-SHENG LIAO, Daya (TW)

(21) Appl. No.: 15/150,414

(22) Filed: May 9, 2016

(30) Foreign Application Priority Data
Jan. 21, 2016 (CN) 201610038163.8

(51) Int. Cl. B60L 11/18; H02J 7/00

(52) U.S. Cl. CPC B60L 11/1844; H02J 7/0047; B60L 11/1846; H02J 7/007; B60L 11/1861; H02J 7/0054; H02J 2007/005

(57) ABSTRACT

An electrical charging or recharging control device applied in moving vehicles includes at least one processor and a storage device that stores one or more programs, when executed by the at least one processor, cause the at least one processor to. A data as to working status transmitted by an electric vehicle is received, the data including information of a position of the electric vehicle, a destination, and a remaining charge level of the electric vehicle. A general electricity demand of the electric vehicle is calculated. A charging request is generated when charging is determined to be necessary according to the general electricity demand and the remaining charge level of the electric vehicle. The charging request leads to the electric vehicle being recharged by a charging vehicle, a charging system and a charging method for a motoring service using the control device are also disclosed.

### FIELD

The subject matter herein generally relates to electric vehicle charging service systems, and particularly to an electrical charging control device, a charging method as a service and a charging system of the service.

### BACKGROUND

Electric vehicles have a lot of advantages, such as zero emissions, no noise, low running costs, and the like, and are becoming more popular. The power of the electric vehicles comes from battery. However, if there are not enough charging stations, usability of the electric vehicles is greatly reduced.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is block diagram of an embodiment of a charging system as a service.

FIG. 2 is a block diagram of an embodiment of a first transmission module of the charging system of FIG. 1.

FIG. 3 is a block diagram of an embodiment of a first charger of the charging system of FIG. 1.

FIG. 4 is a block diagram of an embodiment of a second transmission module of the charging system of FIG. 1.

FIG. 5 is a block diagram of an embodiment of a second charger of the charging system of FIG. 1.

FIG. 6 is a schematic diagram of an embodiment of a first charger and a second charger in charging mode of the charging system of FIG. 1.

FIG. 7 is a schematic diagram of an embodiment of an electrical charging control device of the charging system of FIG. 1.

FIG. 8 is a schematic diagram of an embodiment of a charging vehicle of the charging system of FIG. 1 when charging an electric vehicle.

FIG. 9 is a schematic diagram of an embodiment of another electric vehicle of the charging system of FIG. 1 charging an electric vehicle.

FIG. 10 is a flowchart of an embodiment of the electrical charging control device shown in FIG. 7 applied in a charging method as a service.

FIG. 11 is a flowchart of an embodiment of a charging method applied in the charging system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to an electrical charging control device for charging an electric vehicle. The electrical charging control device includes a receiving module, a processing module electrically coupled to the receiving module, and a transmission module electrically coupled to the processing module. The receiving module receives data as to working status (running status) transmitted by an electric vehicle. The data includes information of a position of the electric vehicle, a destination, and a remaining charge level of the electric vehicle. The processing module calculates a general electricity demand of the electric vehicle that the electric vehicle is driven to the destination from the position of the electric vehicle and then driven back a starting point according to the position of the electric vehicle and the destination. The processing module calculates and determines whether the electric vehicle needs to be charged according to the general electricity demand and the remaining charge level of the electric vehicle. The processing module further generates a charging request when recharging of the electric vehicle is determined to be necessary. The transmission module transmits the charging request to the electric vehicle and a charging vehicle such that the electric vehicle obtains a recharging services.

A charging method of a charging service for charging an electric vehicle (charging service method) is also described. The charging service method comprises: receiving data as to working status (running status) transmitted by an electric vehicle, the data including information of a position of the electric vehicle, a destination, and a remaining charge level of the electric vehicle; calculating a general electricity demand of the electric vehicle that the electric vehicle is driven to the destination from the position of the electric vehicle and then driven back a starting point according to the position of the electric vehicle and the destination; determining whether the electric vehicle needs to be charged according to the general electricity demand and the remaining charge level of the electric vehicle; generating a charging request when recharging the electric vehicle is determined to be necessary, and transmitting a charging request to the electric vehicle and a charging vehicle such that the electric vehicle obtains a recharging service.

A charging system as part of a recharging service (charging service system) is also disclosed. The charging service system includes a charging vehicle and an electrical charging control device. The charging vehicle includes a charger. The electrical charging control device communicates with the charging vehicle. The electrical charging control device receives data as to working status transmitted by an electric vehicle and a charging request transmitted by the electric vehicle. When the electrical charging control device determines that an electric vehicle needs to be charged according to received data or receives a charging request, the electrical charging control device matches the charger of the charging vehicle to the electric vehicle so as to recharge the electric vehicle.

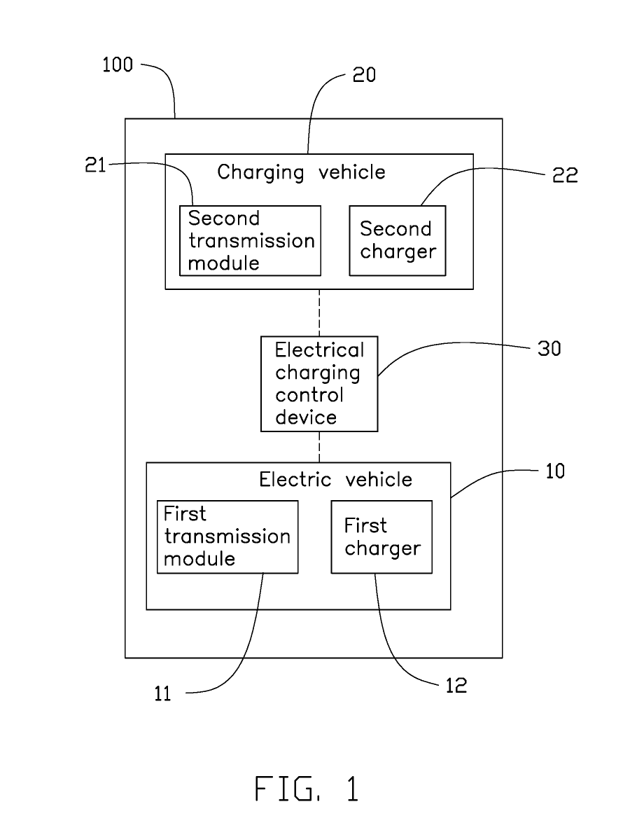

FIG. 1 shows an embodiment of a charging service system 100. The charging service system 100 can include a number of electric vehicles 10 (only one is shown), a number of charging vehicles 20 (only one is shown) and an electrical charging control device 30 communicating with the number of electric vehicles 10 and the number of charging vehicles 20. The charging service system 100 can be configured to charge any number of electric vehicles 10 which need to be charged. In at least one embodiment, the number of electric vehicles 10 can be regarded as rechargeable vehicles.

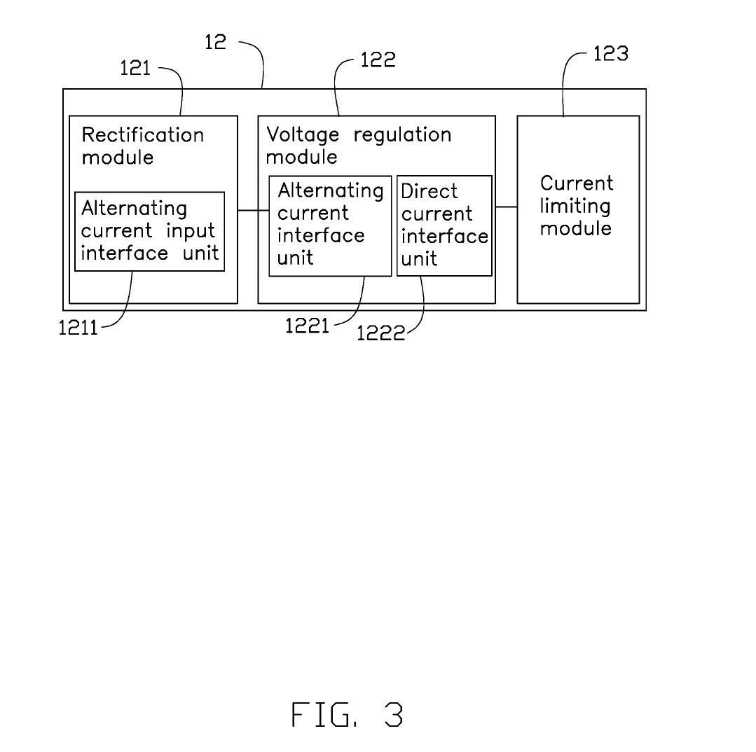

Referring to FIGS. 1-3, the electric vehicle 10 can be driven anywhere or parked anywhere. The electric vehicle 10 can include a first transmission module 11 and a first charger 12. The electric vehicle 10 may also include other configurations to fulfill different functions which are not shown or specifically described.

The first transmission module 11 can be configured to transmit data as to workding status (running status) of the electric vehicle 10 and/or a charging request of the electric vehicle 10 to the electrical charging control device 30. The data can include but is not limited to information as to a destination, an expected arrival time, a remaining charge level of the battery, a travel distance per charge, a moving speed, a position, a charging position, a charging time, and so on. The first transmission module 11 can be further configured to receive a notification transmitted by the electrical charging control device 30, such that information can be notified to a driver of the electric vehicle 10.

The first transmission module 11 can include a display unit 111, an operation unit 112, and a warning unit 113. The operation unit 112 and the warning unit 113 can be both electrically coupled to the display unit 111. The display unit 111 can be configured to display the data, the charging request, and/or the received notification. The display unit 111 can be a console and/or a display screen of the electric vehicle 10. The operation unit 112 can be configured to receive input and generate signals in response of the input. The operation unit 112 can be an input unit of the console and/or the display screen of the electric vehicle 10. The warning unit 113 can be configured to warn the driver of the electric vehicle 10 when the remaining charge level of the battery is low and/or the electric vehicle 10 receives the notification transmitted by the electrical charging control device 30. The warning unit 113 can be configured to generate warnings. The warning can include audible and visual warnings. The warning unit 113 can be configured to warn the driver of the electric vehicle 10 via a voice warning and/or a light warning. The first transmission module 11 can communicate with the electrical charging control device 30 via, but is not limited to, Internet, On-Demand Virtual Leased Line, wireless network including WIFI, BLUETOOTH, or the like, Telephone network including GPRS, CDMA, or the like, Broadcast networks, or the like.

In at least one embodiment, the warning unit 113 of the first transmission module 11 can be omitted.

The first charger 12 can be configured to enable recharging of the electric vehicle 10. The first charger 12 can be further configured to enable the electric vehicle 10 to charge other electric vehicles 10 or even charging vehicles 20. The first charger 12 can include a rectification module 121, a voltage regulation module 122 electrically coupled to the rectification module 121, and a current limiting module 123 electrically coupled to the regulation module 122. The rectification module 121 can be configured to convert alternating current input into the first charger 12 into direct current, such that the alternating current input into the first charger 12 can be rectified. The rectification module 121 can include an alternating current input interface unit 1211. The alternating current input interface unit 1211 can be configured to accept input of alternating current. The voltage regulation module 122 can be configured to control a level of the input voltage or a level of the output voltage. The voltage regulation module 122 can include an alternating current interface unit 1221 and a direct current interface unit 1222 both electrically coupled to the rectification module 121. The alternating current interface unit 1221 can be configured to input direct current rectified by the alternating current input interface unit 1211. The direct current interface unit 1222 can be configured to accept input of direct current. When the provided power is alternating current, the alternating current input interface unit 1211 of the rectification module 121 can be an input interface for charging the electric vehicle 10. When the provided power is direct current, the direct current interface unit 1222 can be an input interface for charging the electric vehicle 10. When the electric vehicle 10 is functioning as a power provider, the direct current interface unit 1222 can be an output interface for charging other electric vehicles 10 or charging vehicles 20. The current limiting module 123 can be configured to control a level of the input current or a level of the output current.

In at least one embodiment, a recharging of the electric vehicle 10 or other suitable vehicles via the first charger 12 is not affected by omitting the rectification module 121 and the alternating current interface unit 1221.

In at least one embodiment, the direct current interface unit 1222 can be only an input interface, which does not affect charging the electric vehicle 12 via the first charger 12.

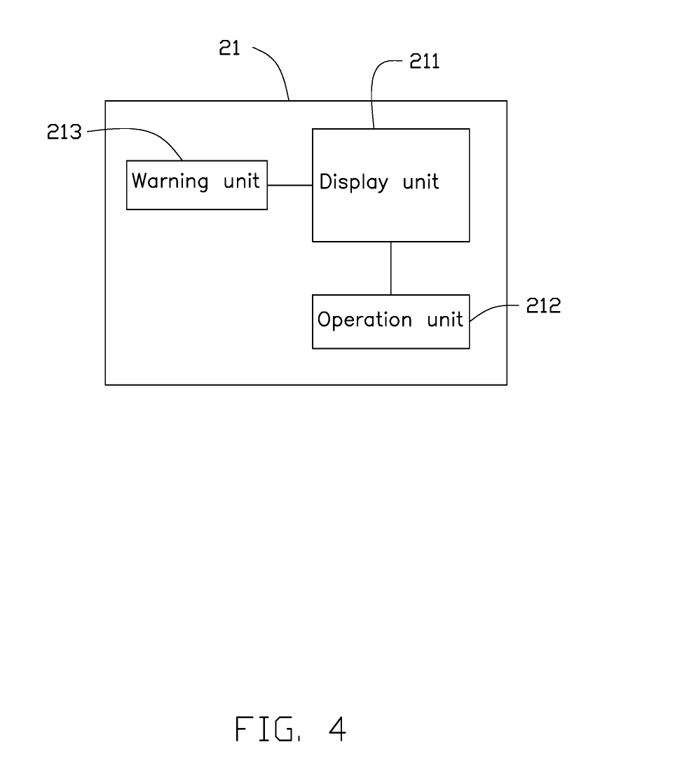

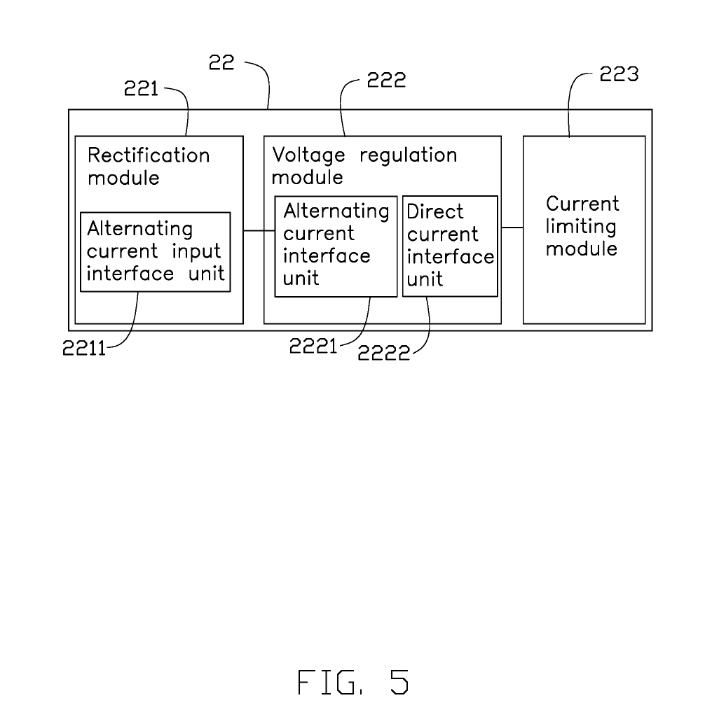

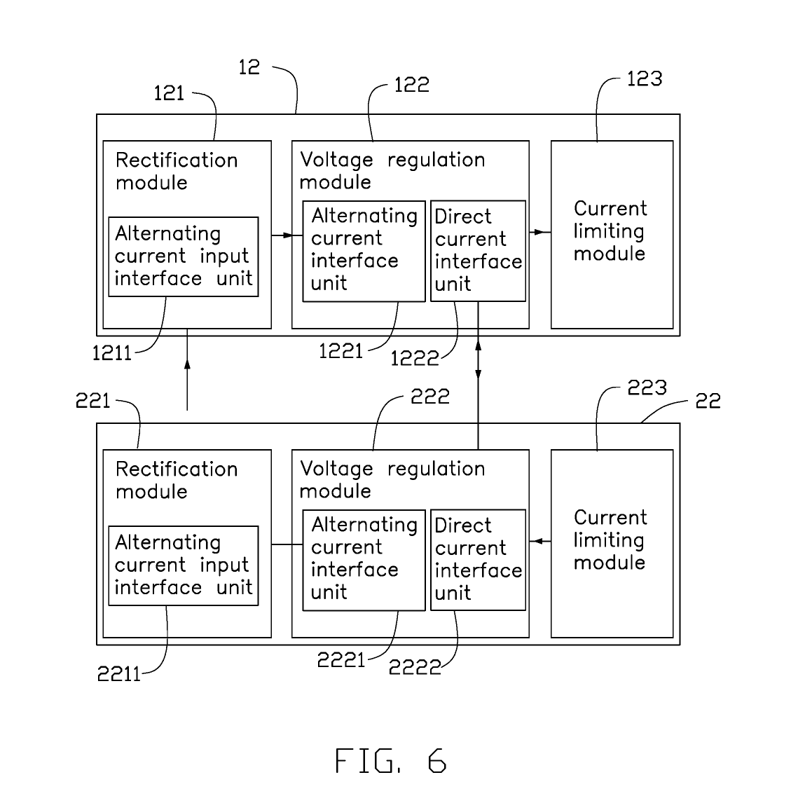

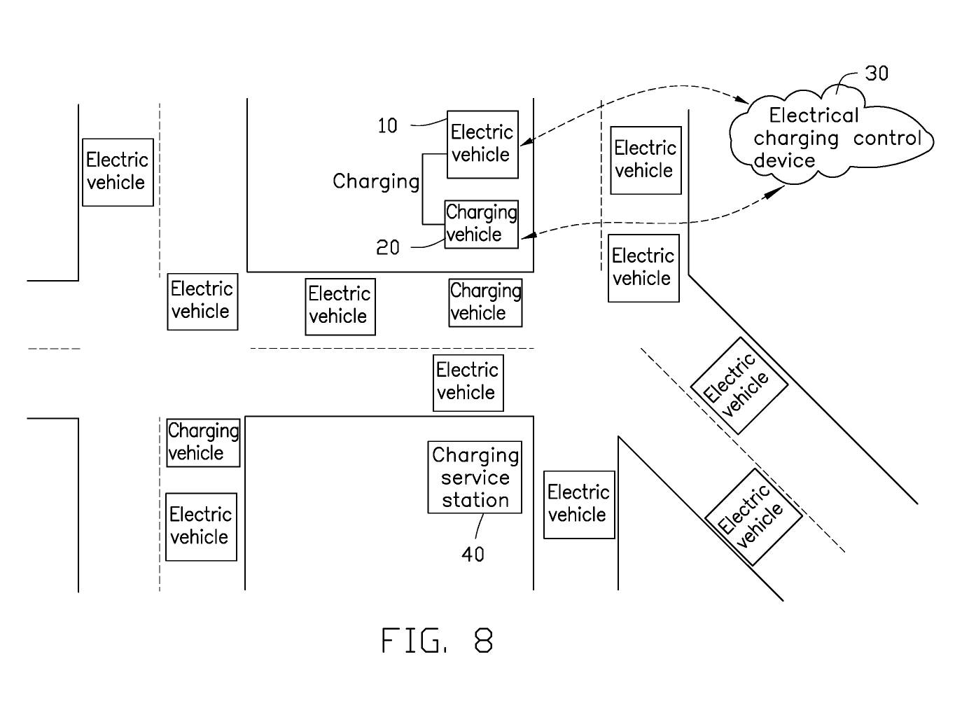

Referring to FIGS. 1, 4, 5 and 6, the charging vehicle 20 can be charged by a charging station 40 (as shown in FIG. 8). The charging vehicle 20 can be parked at a gas station, a parking lot, a convenience store, or so on. The charging vehicle 20 can be placed on standby and further assigned to go to a certain position to charge the electric vehicle 10. The charging vehicle 20 can include a second transmission module 21 and a second charger 22. The charging vehicle 20 may also include other configurations to fulfill different functions which are not shown and not specifically described.

The second transmission module 21 can be configured to transmit a charging request of the charging vehicle 20 to the electrical charging control device 30. The second transmission module 21 can be further configured to receive a notification transmitted by the electrical charging control device 30, such that a driver of the charging vehicle 20 can be given information contained in the notification. The second transmission module 21 can be similar to the first transmission module 11. The second transmission module 21 can include a display unit 211, an operation unit 212, and a warning unit 213 but which are not shown nor specifically described, for purposes of simplicity. The second transmission module 21 can communicate with the electrical charging control device 30 via, but is not limited to, Internet, On-Demand Virtual Leased Line, wireless network including WIFI, BLUETOOTH or the like, Telephone network including GPRS, CDMA, or the like, Broadcast networks, or the like.

The second charger 22 enables charging of the charging vehicle 20. The second charger 22 can also be configured to enable the charging vehicle 20 to charge other charging vehicles 20. The second charger 22 can be similar to the first charger 12. The second charger 22 can include a rectification module 221, a voltage regulation module 222 electrically coupled to the rectification module 221, and a current limiting module 223 electrically coupled to the regulation module 222. The rectification module 221 can be configured to convert alternating current input into the second charger 22 into direct current, such that the alternating current input into the second charger 22 can be rectified. The rectification module 221 can include an alternating current input interface unit 2211. The alternating current input interface unit 2211 can be configured to accept input of alternating current. The voltage regulation module 222 can be configured to control a level of the input voltage or a level of the output voltage. The voltage regulation module 222 can include an alternating current interface unit 2221 and a direct current interface unit 2222 both electrically coupled to the rectification module 221. The alternating current interface unit 2221 can be configured to input direct current rectified by the alternating current input interface unit 2211. The direct current interface unit 2222 can be configured to accept input of current directly. When the provided power is alternating current, the alternating current input interface unit 2211 of the rectification module 221 can be an input interface for charging the electric vehicle 10. When the provided power is direct current, the direct current interface unit 2222 can be an input interface for charging the charging vehicle 20. When the charging vehicle 20 is functioning as a power provider, the direct current interface unit 2222 can be an output interface for charging electric vehicles 10 or charging vehicles 20. The current limiting module 223 can be configured to control a level of the input current or a level of the output current.

In at least one embodiment, the charging of the charging vehicle 20 or other vehicles by the second charger 22 is not affected by omitting the rectification module 221 and the alternating current interface unit 2221.

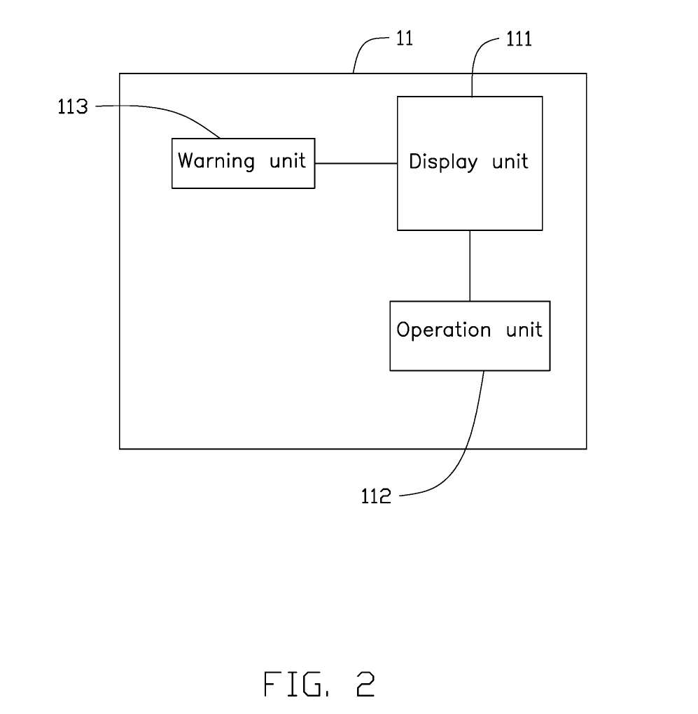

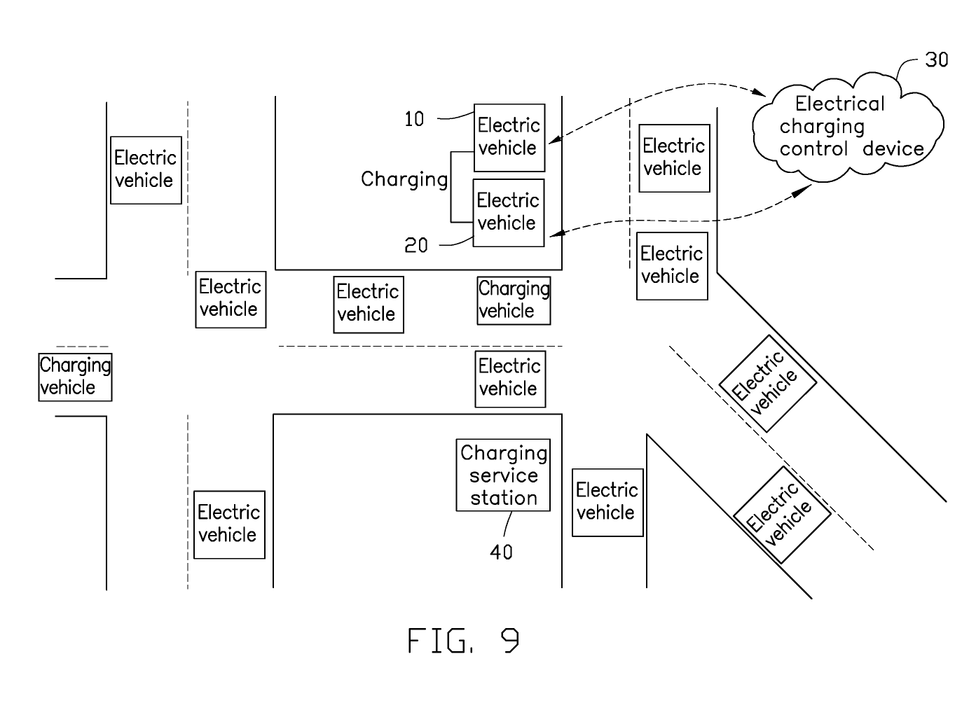

Referring to FIGS. 2, 4, and 7-9, the electrical charging control device 30 can communicate with the first transmission module 11 of the electric vehicle 10 and the second transmission module 21 of the charging vehicle 20.

The electrical charging control device 30 can include a receiving module 31, a processing module 32 electrically coupled to the receiving module 31, a transmission module 33 electrically coupled to the processing module 32, and a storage module 34.

The receiving module 31 can receive the charging request transmitted by the electric vehicle 10 and/or the charging vehicle 20. The above charging request can include but is not limited to information as to the destination, the expected arrival time, the remaining charge level of the battery, the travel distance per charge, the moving speed, the position, the charging position, the charging time, and so on.

The processing module 32 can calculate a general electricity demand of the electric vehicle 10 that the electric vehicle 10 is driven to the destination from the position of the electric vehicle 10 and then driven back a starting point according to the destination and the position contained in the charging request. In at least one embodiment, the processing module 32 can further calculate the general electricity demand according to the traffic information.

The processing module 32 can further determine whether the electric vehicle 10 needs to be charged according to the general electricity demand and the remaining charge level of the battery. If the general electricity demand is less than the remaining charge level of the battery, it is indicated that the electric vehicle 10 does not need to be charged. If the general electricity demand is greater than the remaining charge level of the battery, it is indicated that the electric vehicle 10 needs to be charged.

The processing module 32 can search out a charging station 40 which is nearby the electric vehicle 10 in a database, according to the position of the electric vehicle 10. The processing module 32 can further control the transmission module 33 to transmit a position of the charging station 40 to the electric vehicle 10, such that the electric vehicle 10 can be driven to the position of the charging station 40 and charged by the charging station 40.

The processing module 32 can further search out the charging vehicles 20 and/or other electric vehicles 10 within a certain distance of the electric vehicle 10 according to the position of the electric vehicle 10.

The processing module 32 can further inform one of the charging vehicles 20 within a certain distance of the electric vehicle 10 or one of the other electric vehicles 10 within a certain distance of the electric vehicle 10, to charge the electric vehicle 10 via the transmission module 33.

The processing module 32 can assign a charging position according to the relative positions of the electric vehicle 10 and the charging vehicles 20.

In at least one embodiment, the processing module 32 can be a central processing unit, a digital signal processor, or a single chip, for example. The processing module 32 can include functions represented by hardware or integrated circuits, or as software and hardware combinations, such as a special-purpose processor or a general-purpose processor with special-purpose firmware.

The transmission module 33 can transmit the charging position to the electric vehicle 10 and the one of the charging vehicles 20 or the one of the other electric vehicles 10, such that the electric vehicle and the charging vehicle both go to the charging position to finish a charging service.

The storage module 34 can be configured to store the data, the charging request, the charging service, and the position of the charging station 40.

In at least one embodiment, the storage module 34 can be an internal storage system, such as a flash memory, a random access memory (RAM) for temporary storage of information, and/or a read-memory (ROM) for permanent storage of information.

In at least one embodiment, the storage module 34 can also be a storage system, such as a hard disk, a storage card, or a data storage medium. The storage module 34 can include volatile and/or non-volatile storage devices.

In at least one embodiment, the storage module 34 can include two or more storage devices such that one storage device is a memory and the other storage device is a hard drive. Additionally, the storage module 34 can be either entirely or partially external relative to the electrical charging control device 30.

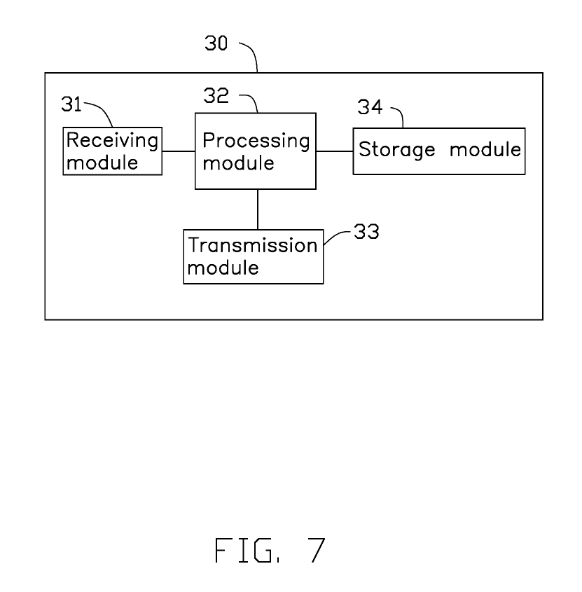

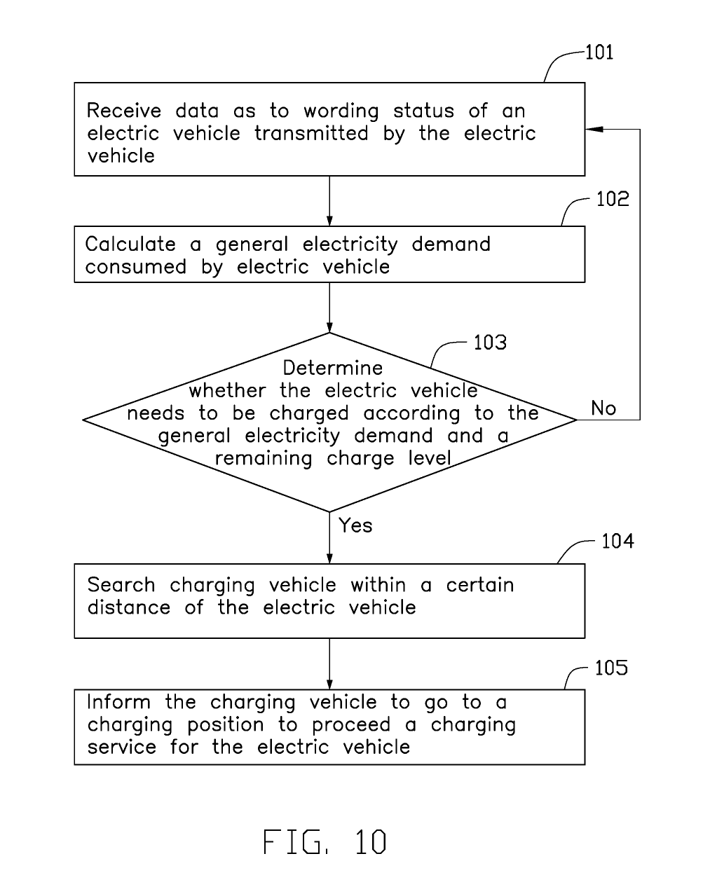

Referring to FIG. 10, a block diagram of an embodiment of a charging service method is illustrated. The charging service method is provided by way of example, as there are a variety of ways to carry out the method. The charging service method described below can be carried out using the configurations illustrated in FIG. 7 for example, and various elements of these figures are referenced in explaining the example method. Each block shown in FIG. 10 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, a receiving module of an electrical charging control device receives a data as to working status (running status) of an electric vehicle transmitted by the electric vehicle. The data can include but is not limited to information of an electric vehicle's of destination, an expected arrival time, a remaining charge level of a battery, a travel distance per charge, a moving speed, a position, a charging position, a charging time, and/or so on.

At block 102, a processing module of the electrical charging control device calculates a general electricity demand consumed by an electric vehicle when the electric vehicle is driven to the destination and then driven back a starting point according to the destination and the position.

At block 103, the processing module determines whether the electric vehicle needs to be charged according to the general electricity demand and the remaining charge level of the battery, if yes, the process goes to block 104, otherwise, the process continues block 101.

At block 104, the processing module searches out a charging vehicle within a certain distance of the electric vehicle according to the position of the electric vehicle.

At block 105, the processing module informs the charging vehicle to go to a charging position to proceed a charging service for the electric vehicle via a transmission module of the electrical charging control device.

The processing module further informs the charging vehicle to go to the charging position to proceed the charging service for the electric vehicle according to the charging request.

In at least one embodiment, the electrical charging control device 30 can be a cloud server or a domestic embedded electric device.

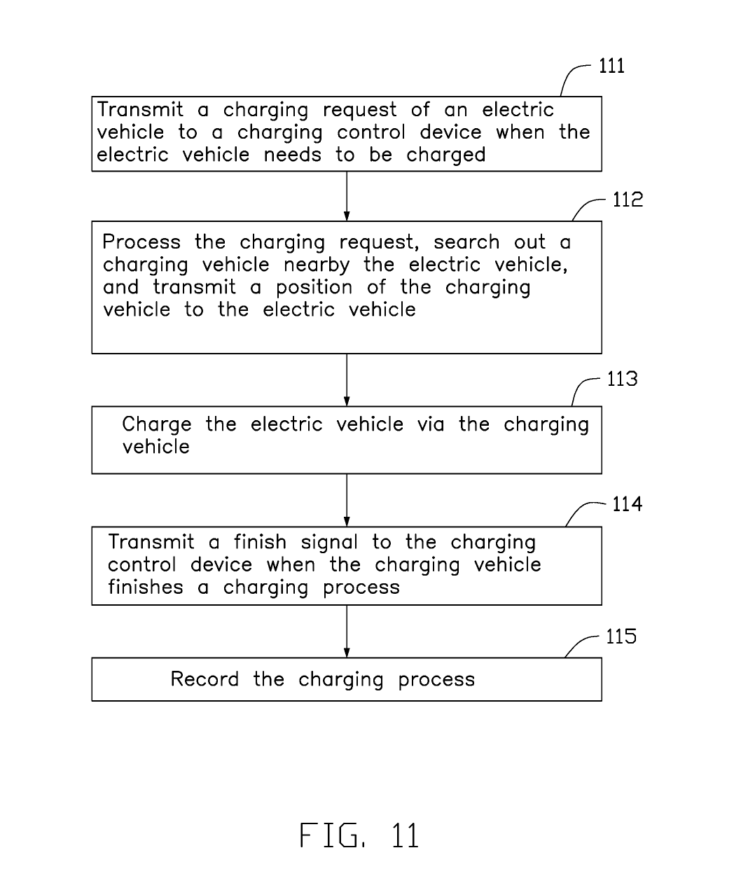

Referring to FIG. 11, a block diagram of an embodiment of an electric vehicle charging service method is illustrated. The charging service method is provided by way of example, as there are a variety of ways to carry out the method. The charging service method described below can be carried out using the configurations illustrated in FIGS. 1 and 7 for example, and various elements of these figures are referenced in explaining the example method. Each block shown in FIG. 11 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 111.

At block 111, a first transmission module of an electric vehicle transmits a charging request of the electric vehicle to an electrical charging control device when the electric vehicle needs to be charged. The charging request includes but is not limited to information of a destination, an expected arrival time, a remaining charge level of a battery, a travel distance per charge, a moving speed, a position, a charging position, a charging time, and/or so on.

At block 112, the electrical charging control device processes the charging request, and search out a charging vehicle nearby the electric vehicle in a database according to the position of the electric vehicle, and transmits the position of the electrical charging control device to the electric vehicle, such that the electric vehicle is driven to the position of the electrical charging control device and charged by the electrical charging control device.

At block 113, the charging vehicle charges the electric vehicle.

At block 114, the charging vehicle transmits a finish signal to the electrical charging control device when the charging vehicle finishes charging.

At block 115, the electrical charging control device recorded the charging process.

In at least one embodiment, the charging vehicle can answer the electrical charging control device whether the charging vehicle can finish the charging process.

The embodiments shown and described above are only examples. Many details are often found in the art such as the features of electrical charging control device and charging method and charging system thereof. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An electrical charging control device, comprising:
at least one processor; and
a storage device that stores one or more programs, when executed by the at least one processor, cause the at least one processor to;
receiving a data as to working status transmitted by an electric vehicle, the data including information of a position of the electric vehicle, a destination, and a remaining charge level of the electric vehicle;
calculating a general electricity demand of the electric vehicle that the electric vehicle is driven to the destination from the position of the electric vehicle and then driven back a starting point;
determining whether the electric vehicle needs to be charged according to the general electricity demand and the remaining charge level of the electric vehicle;
generating a charging request when recharging the electric vehicle is determined to be necessary; and
transmitting the charging request to the electric vehicle and a charging vehicle such that the electric vehicle obtains a recharging service.

2. The electrical charging control device of claim 1, further comprising:
calculating the general electricity demand further according to traffic information.

3. The electrical charging control device of claim 1, further comprising:
searching out the charging vehicle within a certain distance of the electric vehicle according to the position of the electric vehicle; and
informing the charging vehicle to charge the electric vehicle.

4. The electrical charging control device of claim 1, further comprising:
calculating a charging position according to the position of the electric vehicle and a position of the charging vehicle; and
transmitting the charging position to the electric vehicle and the charging vehicle, such that the electric vehicle and the charging vehicle both go to the charging position to finish the charging service.

5. The electrical charging control device of claim 4, further comprising:
storing the data, and the charging service.

6. A charging method, comprising:
receiving a data as to working status transmitted by an electric vehicle, the data including information of a position of the electric vehicle, a destination, and a remaining charge level of the electric vehicle;
calculating a general electricity demand of the electric vehicle that the electric vehicle is driven to the destination from the position of the electric vehicle and then driven back a starting point;
determining whether the electric vehicle needs to be charged according to the general electricity demand and the remaining charge level of the electric vehicle;
generating a charging request when recharging the electric vehicle is determined to be necessary; and
transmitting a charging request to the electric vehicle and a charging vehicle such that the electric vehicle obtains a recharging service.

7. The charging method of claim 6, wherein the charging service method further comprises:
calculating the general electricity demand further according to traffic information.

8. The charging method of claim 6, wherein the charging service method further comprises:
searching out the charging vehicle within a certain distance of the electric vehicle according to the position of the electric vehicle; and
informing the charging vehicle to charge the electric vehicle.

9. The charging method of claim 6, wherein the charging service method further comprises:
calculating a charging position according to the position of the electric vehicle and the position the charging vehicle; and
transmitting the charging position to the electric vehicle and the charging vehicle, such that the electric vehicle and the charging vehicle both go to the charging position to finish the charging service.

10. The charging method of claim 9, wherein the charging service method further comprises:
storing the data, and the charging service.

11. A charging system, comprising:
a charging vehicle, the charging vehicle comprising:
a charger; and
an electrical charging control device communicated with the charging vehicle, the electrical charging control device receiving a data as to working status transmitted by an electric vehicle or a charging request transmitted by the electric vehicle;
wherein when the electrical charging control device determines that the electric vehicle needs to be charged according to received data or receives the charging request, the electrical charging control device matches the charger of the charging vehicle to a charger of the electric vehicle so as to charge the electric vehicle.

12. The charging system of claim 11, wherein the charging vehicle further comprises a transmission module for transmitting a charging request to the electrical charging control device, the electrical charging control device processes the charging request of the charging vehicle, matches the charger of the charging vehicle to a charger of another electric vehicle so as to charge the charging vehicle.

13. The charging system of claim 12, wherein the transmission module comprises a display unit and an operation unit electrically coupled to the display unit, the display unit displays the charging request of the charging vehicle, the operation unit receives input operations applied thereon.

14. The charging system of claim 13, wherein the transmission module further comprises a warning unit electrically coupled to the display unit, the warning unit is configured to generate a warning, when a remaining charge level of the charging vehicle is low.

15. The charging system of claim 14, wherein the warning comprises light warning and voice warning.

16. The charging system of claim 11, wherein the charger comprises a voltage regulation module and a current limiting module electrically coupled to the voltage regulation module, the voltage regulation module controls a level of input voltage or a level of output voltage, the current limiting module controls a level of input current or a level of output current.

17. The charging system of claim 16, wherein the charger further comprises a rectification module electrically coupled to voltage regulation module, the rectification module converts alternating current input into direct current, such that the alternating current input into the charger is rectified.

18. The charging system of claim 17, wherein the rectification module comprises an alternating current input interface unit, the alternating current input interface unit is configured to input alternating current, the current input interface unit is an input interface for charging.

19. The charging system of claim 18, wherein the voltage regulation module comprises a direct current interface unit electrically coupled to the rectification module, the direct current interface unit is configured to input direct current directly, the direct current interface unit is an output interface or an input interface.

20. The charging system of claim 19, wherein the voltage regulation module comprises an alternating current interface unit electrically coupled to the rectification module, the alternating current interface unit is configured to input direct current rectified by the rectification module.
